(19) United States
(12) Patent Application Publication
(10) Pub. No.: US 2026/0316241 A1
(43) Pub. Date: Oct. 15, 2026

(54) POWER TOOL

(71) Applicant: Nanjing Chervon Industry Co., Ltd., Nanjing (CN)

(72) Inventors: Jingdong Hao, Nanjing (CN); Bin Yang, Nanjing (CN); Mingqi Zhou, Nanjing (CN); Junyong Yang, Nanjing (CN); Da Li, Nanjing (CN)

(21) Appl. No.: 19/467,311

(22) Filed: Feb. 2, 2026

Related U.S. Application Data
(63) Continuation of application No. PCT/CN2024/117649, filed on Sep. 9, 2024.

(30) Foreign Application Priority Data
Sep. 27, 2023 (CN) 202311257589.9
Sep. 27, 2023 (CN) 202311261298.7
Sep. 27, 2023 (CN) 202311267443.2
Sep. 27, 2023 (CN) 202322645506.5
Sep. 27, 2023 (CN) 202322645843.4

(51) Int. Cl. B25C 1/04

(52) U.S. Cl. CPC B25C 1/047

(57) ABSTRACT

A power tool includes a cylinder at least partially disposed in a housing, where gas is stored in the cylinder. The cylinder includes: an inflation nozzle, where the cylinder is inflated with the gas in advance through the inflation nozzle; an inflation valve, where the gas filled through the inflation nozzle flows through the inflation valve and then enters the cylinder; and a pressure relief valve disposed between the inflation nozzle and the inflation valve, where when a pressure of the gas filled through the inflation nozzle is greater than a first preset pressure, the filled gas is released through the pressure relief valve.

### RELATED APPLICATION INFORMATION

This application is a continuation of International Application Number PCT/CN2024/117649, filed on Sep. 9, 2024, through which this application also claims the benefit under 35 U.S.C. § 119(a) of Chinese Patent Application No. CN 202311267443.2, filed on Sep. 27, 2023, Chinese Patent Application No. CN 202311261298.7, filed on Sep. 27, 2023, Chinese Patent Application No. CN 202311257589.9, filed on Sep. 27, 2023, Chinese Patent Application No. CN 202322645843.4, filed on Sep. 27, 2023, and Chinese Patent Application No. CN 202322645506.5, filed on Sep. 27, 2023, which application are incorporated herein by reference in their entireties.

### BACKGROUND

A nail gun in the related art is used as a nailing tool. Nail guns in the market may be classified into mechanical nail guns and cylinder-type nail guns according to principle modes. The mechanical nail guns may be classified into spring-type nail guns, flywheel-type nail guns, and friction-wheel-type nail guns according to energy storage modes. The cylinder-type nail guns may be classified into single-cylinder nail guns and double-cylinder nail guns according to the number of cylinders. The cylinder-type nail guns may be classified into nail guns with positive-pressure energy storage and nail guns with negative-pressure energy storage according to energy storage modes.

In the related art, a cylinder-type nail gun compresses gas in a cylinder, and the gas pushes out a firing assembly to perform nailing. Gas is pre-filled, through an inflation nozzle, into a nail gun inflated with gas in advance. Therefore, no external air pressure source is required. In an inflation process, a cylinder, the inflation nozzle, and components in the cylinder are easily damaged by an excessive inflation pressure.

This part provides background information related to the present application, and the background information is not necessarily the existing art.

### SUMMARY

An object of the present application is to solve or at least alleviate part or all of the preceding problems. Therefore, an object of the present application is to provide a power tool with cylinder components that can be protected.

To achieve the preceding object, the present application adopts the technical solutions below.

An example of the present application provides a power tool. The power tool includes: a housing; a power output portion at least partially disposed in the housing; a cylinder at least partially disposed in the housing, where gas is stored in the cylinder; and a piston driven by the power output portion, where the piston is disposed in the cylinder and moves in the cylinder to compress the gas in the cylinder. The cylinder includes: an inflation nozzle, where the cylinder is inflated with the gas in advance through the inflation nozzle; an inflation valve, where the gas filled through the inflation nozzle flows through the inflation valve and then enters the cylinder; and a pressure relief valve disposed between the inflation nozzle and the inflation valve, where when a pressure of the gas filled through the inflation nozzle is greater than a first preset pressure, the filled gas is released through the pressure relief valve.

In some examples, the pressure relief valve allows one-way flow.

In some examples, the inflation valve allows one-way flow.

In some examples, the inflation valve restricts the gas in the cylinder from flowing out of the cylinder through the inflation valve.

In some examples, the inflation valve restricts the gas from entering the cylinder when a pressure in the cylinder exceeds a second preset pressure.

In some examples, the first preset pressure is less than or equal to the second preset pressure.

In some examples, the cylinder includes: a cylinder barrel portion provided with a chamber, where the chamber is configured to store the gas; and an inflation portion connected to the chamber through the inflation valve.

In some examples, the inflation portion includes a gas passage portion, the inflation nozzle and the inflation valve are disposed at two ends of the gas passage portion, and the pressure relief valve is disposed on the gas passage portion.

In some examples, when the pressure relief valve and the inflation valve are in a closed state, a gas pressure in the gas passage portion is greater than or equal to atmospheric pressure.

In some examples, the gas passage portion forms a second gas chamber, the second gas chamber has a certain length, and the pressure relief valve releases the gas along a direction intersecting with a length direction of the second gas chamber.

In some examples, the cylinder includes an inner cylinder, and the piston moves in the inner cylinder.

In some examples, the cylinder further includes an outer cylinder disposed around the inner cylinder, the inner cylinder communicates with the outer cylinder, and the inflation nozzle, the inflation valve, and the pressure relief valve are disposed on the outer cylinder separately.

In some examples, a first threaded segment is provided on an outer sidewall of the inner cylinder, a second threaded segment is provided on an inner sidewall of the outer cylinder, and the first threaded segment meshes with the second threaded segment.

In some examples, an inflation hole corresponding to the inflation nozzle is included on the housing; and a retaining member is further included, the retaining member is configured to fix the cylinder, the retaining member includes a positioning portion, the positioning portion is at least partially disposed on the cylinder, and the positioning portion indicates a position where the inflation nozzle is assembled with the inflation hole.

In some examples, the positioning portion includes a first indicating structure, the cylinder is provided with a second indicating structure, and when the first indicating structure and the second indicating structure meet a preset relationship, the cylinder is fixed at a preset position causing the inflation nozzle to correspond to the inflation hole.

An example of the present application provides a power tool. The power tool includes: a housing; a power output portion at least partially disposed in the housing; a cylinder at least partially disposed in the housing, where gas is stored in the cylinder; a piston driven by the power output portion, where the piston is disposed in the cylinder and moves in the cylinder to compress the gas in the cylinder; an inflation nozzle, where the cylinder is inflated with the gas in advance through the inflation nozzle; and a one-way pressure relief valve disposed on an inflation downstream side of the inflation nozzle, where the one-way pressure relief valve communicates with an outside of the cylinder for an escape of the gas.

An example of the present application provides a power tool. The power tool includes: a housing; a power output portion at least partially disposed in the housing; a cylinder at least partially disposed in the housing, where gas is stored in the cylinder; and a piston driven by the power output portion, where the piston is disposed in the cylinder and moves in the cylinder to compress the gas in the cylinder. The cylinder includes: an inflation nozzle, where the cylinder is inflated with the gas in advance through the inflation nozzle, and the inflation nozzle restricts the gas from being released from the inflation nozzle; and a one-way pressure relief valve disposed on an inflation downstream side of the inflation nozzle, where when a pressure of the gas filled through the inflation nozzle is greater than a first preset pressure, the filled gas is released through the one-way pressure relief valve.

In some examples, the cylinder includes an inner cylinder, and the piston moves in the inner cylinder.

In some examples, the cylinder further includes an outer cylinder disposed around the inner cylinder, the inner cylinder communicates with the outer cylinder, and the inflation nozzle and the one-way pressure relief valve are disposed on the outer cylinder separately.

In some examples, a first threaded segment is provided on an outer sidewall of the inner cylinder, a second threaded segment is provided on an inner sidewall of the outer cylinder, and the first threaded segment meshes with the second threaded segment.

An example of the present application provides a power tool. The power tool includes: a housing; a motor at least partially disposed in the housing; and a circuit board assembly electrically connected to the motor to control the motor, where the circuit board assembly includes a first heat dissipation portion, and at least part of the first heat dissipation portion is in thermal contact with a circuit board provided with a controller; a second heat dissipation portion disposed outside the circuit board assembly, where the second heat dissipation portion includes a core and a housing portion having a heat dissipation capability, and the core includes at least a phase transition material; and a heat conduction portion, where the heat conduction portion connects the circuit board assembly to the second heat dissipation portion so that the circuit board assembly and the second heat dissipation portion are in thermal contact.

In some examples, the core undergoes a phase transition reaction at a preset temperature to cool the housing portion.

In some examples, the preset temperature is lower than a temperature of the first heat dissipation portion.

In some examples, the housing portion includes a metal material.

In some examples, the housing portion forms an openable sealed chamber, and the core is accommodated in the sealed chamber.

In some examples, the heat conduction portion includes a metal material.

In some examples, the heat conduction portion connects the first heat dissipation portion to the housing portion.

In some examples, the first heat dissipation portion includes a fin heat dissipation structure.

In some examples, the first heat dissipation portion includes at least a phase transition material.

An example of the present application provides a power tool. The power tool includes: a housing; a heat generation component at least partially disposed in the housing, where the heat generation component generates a temperature rise when the power tool runs; a first heat dissipation portion, where at least part of the first heat dissipation portion is in thermal contact with the heat generation component; a second heat dissipation portion disposed outside the heat generation component, where the second heat dissipation portion includes a core and a housing portion having a heat dissipation capability, and the core includes at least a phase transition material; and a heat conduction portion, where the heat conduction portion connects at least one of the heat generation component and the first heat dissipation portion to the second heat dissipation portion so that the heat generation component and the second heat dissipation portion are in thermal contact.

An example of the present application provides a power tool. The power tool includes: a housing; a power output portion at least partially disposed in the housing; a cylinder at least partially disposed in the housing, where gas is stored in the cylinder; and a piston disposed in the cylinder and driven by the power output portion, where the piston moves in the cylinder to compress the gas in the cylinder. The cylinder includes: a first chamber, where the piston moves in the first chamber; a second chamber communicating with the first chamber; and an adjustment assembly including a first state and a second state. When the piston is at the same position in the first chamber, the first chamber and the second chamber define a first effective volume when the adjustment assembly is in the first state, and the first chamber and the second chamber define a second effective volume when the adjustment assembly is in the second state. The first effective volume is less than the second effective volume.

In some examples, a defined volume of the first chamber is related to a position to which the piston moves.

In some examples, the defined volume of the first chamber is not related to a state of the adjustment assembly.

In some examples, the adjustment assembly is at least partially disposed in the second chamber, and a defined volume of the second chamber is related to the state of the adjustment assembly.

In some examples, the adjustment assembly includes: an operation member driven to switch the working state of the adjustment assembly; and an adjustment piston driven by the operation member to move in the second chamber.

In some examples, the adjustment piston and an inner wall of the second chamber define the volume of the second chamber.

In some examples, the adjustment assembly further includes a connection portion, the connection portion connects the operation member to the adjustment piston, and the connection portion is driven by the operation member to move the adjustment piston and retains a position of the adjustment piston when the operation member is released.

In some examples, a sealing ring is disposed on an outer side of the adjustment piston.

In some examples, the power tool further includes: a striker disposed on the piston and configured to drive a nail out; and a driving member driven by the power output portion, so as to mate with the striker to drive the piston to move in the cylinder and compress the gas.

An example of the present application provides a power tool. The power tool includes: a housing; a power output portion at least partially disposed in the housing; a cylinder at least partially disposed in the housing, where gas is stored in the cylinder; and a firing assembly at least partially disposed in the cylinder, where the firing assembly is movable from an energy storage position to a firing position in the cylinder to drive a nail out. The cylinder includes: a first chamber, where the firing assembly moves in the first chamber; a second chamber communicating with the first chamber; and an adjustment assembly including a first state and a second state. When the cylinder is inflated with the same volume of gas, a striking force applied to the nail by the firing assembly when the adjustment assembly is in the first state is greater than a striking force applied to the nail by the firing assembly when the adjustment assembly is in the second state.

An example of the present application provides a power tool. The power tool includes: a housing; a power output portion at least partially disposed in the housing; a cylinder at least partially disposed in the housing, where gas is stored in the cylinder; a piston disposed in the cylinder, where the piston is driven by the power output portion and moves in the cylinder to compress the gas in the cylinder; an inflation nozzle, where the cylinder is inflated with the gas in advance through the inflation nozzle, and an inflation hole corresponding to the inflation nozzle is included on the housing; and a retaining member configured to fix the cylinder. The retaining member includes a positioning portion, the positioning portion includes a first indicating structure, and the cylinder is provided with a second indicating structure. When the first indicating structure and the second indicating structure meet a preset relationship, the cylinder is fixed at a preset position causing the inflation nozzle to correspond to the inflation hole.

In some examples, the cylinder includes: an inner cylinder, where the piston moves in the inner cylinder; and an outer cylinder disposed around the inner cylinder, where the inner cylinder communicates with the outer cylinder, and the retaining member connects the inner cylinder to the outer cylinder.

In some examples, the inner cylinder is rotatably connected to the outer cylinder, and the positioning portion indicates a rotation ending point of the outer cylinder.

In some examples, the retaining member includes a first threaded segment provided on an outer sidewall of the inner cylinder and a second threaded segment provided on an inner sidewall of the outer cylinder, and the first threaded segment meshes with the second threaded segment.

In some examples, the retaining member further includes a retaining ring disposed on an outer side of the outer cylinder, and the retaining ring restricts loosening of the meshing between the first threaded segment and the second threaded segment.

In some examples, the first indicating structure is formed on or connected to the retaining ring.

In some examples, the retaining member further includes a support base, and the support base is fixed to the inner cylinder and positions the inner cylinder and the housing.

In some examples, the first indicating structure is formed on or connected to the support base.

In some examples, a striker is further included, where the striker is disposed on the piston, is configured to drive a nail out, and extends out of the cylinder; and a dustproof portion is further included, where the dustproof portion is disposed at a position where the striker extends out of the cylinder, so as to restrict dust on the striker from entering the cylinder.

An example of the present application provides a power tool. The power tool includes: a housing; a power output portion at least partially disposed in the housing; a cylinder at least partially disposed in the housing, where gas is stored in the cylinder; a piston disposed in the cylinder, where the piston is driven by the power output portion and moves in the cylinder to compress the gas in the cylinder; an inflation nozzle, where the cylinder is inflated with the gas in advance through the inflation nozzle, and an inflation hole corresponding to the inflation nozzle is included on the housing; and a retaining member configured to fix the cylinder. The retaining member includes a positioning portion. The positioning portion is at least partially disposed on the cylinder, and the positioning portion indicates a position where the inflation nozzle is assembled with the inflation hole.

An example of the present application provides a nail gun. The nail gun includes: a housing; a power output portion at least partially disposed in the housing; a firing assembly, where the firing assembly moves from an energy storage position to a firing position to drive a nail out and includes a first lifting portion; and a driving member driven by the power output portion. The driving member is configured to drive the firing assembly to move from the firing position to the energy storage position. The driving member includes a first driving portion. The first driving portion meshes with the first lifting portion to cause the firing assembly to start moving from the firing position to the energy storage position. The first driving portion includes a first avoidance portion configured to avoid a second lifting portion below the first lifting portion.

In some examples, the firing assembly further includes a third lifting portion, a first rotary shaft is disposed on the third lifting portion, a roller is disposed on the first rotary shaft, and the roller rotates about a first rotation axis.

In some examples, a radius of the roller is greater than or equal to a length of a connection line between a tooth top of the third lifting portion and a shaft center of the first rotary shaft.

In some examples, a width of the first lifting portion is greater than a width of the first avoidance portion, and a width of the second lifting portion is less than or equal to the width of the first avoidance portion.

In some examples, a second rotary shaft is disposed on the first lifting portion, rollers are disposed on the second rotary shaft, and the rollers rotate about a second rotation axis.

In some examples, the driving member further includes a second driving portion, the second driving portion meshes with the second lifting portion below the first lifting portion, and a width of the second driving portion is substantially the same as a width of the first driving portion.

In some examples, the driving member includes a third driving portion mating with the third lifting portion, and a wall surface of the third driving portion in contact with the roller is a smooth surface.

In some examples, the nail gun further includes: a cylinder configured to store gas, where the firing assembly includes a piston disposed in the cylinder; and a striker disposed on the piston, where the first lifting portion, the second lifting portion, and the third lifting portion are provided on the striker to move the piston in the cylinder.

In some examples, the first lifting portion, the second lifting portion, and the third lifting portion are sequentially provided at increasing distances from the piston.

In some examples, the first avoidance portion is configured to cause the second lifting portion to penetrate through or pass the first driving portion along a movement direction of the firing assembly.

In some examples, the first avoidance portion is configured to be a groove that is on the first driving portion and extends along the movement direction of the firing assembly.

### BRIEF DESCRIPTION OF THE DRAWINGS

FIG. 1 is a perspective view of a nail gun in an example of the present application.

FIG. 2 is a partial sectional view of the nail gun in FIG. 1.

FIG. 3 is a sectional view of some components in FIG. 1, showing a motor, a transmission apparatus, and a fan assembly.

FIG. 4 is a sectional view of some components in FIG. 1, showing a cylinder and a firing assembly, where the firing assembly is at a firing position.

FIG. 5 is a sectional view of some components in FIG. 1, showing a cylinder and a firing assembly, where the firing assembly is at an energy storage position.

FIG. 6 is a perspective view of some components in FIG. 1, showing a power output portion and a firing assembly, where the firing assembly is at a firing position.

FIG. 7 is a partial sectional view of FIG. 6.

FIG. 8 is a perspective view of some components in FIG. 1, showing a power output portion and a firing assembly, where the firing assembly is at an energy storage position.

FIG. 9 is a structural view of a driving member and a striker in FIG. 6.

FIG. 10 is a sectional view taken along B-B in FIG. 9.

FIG. 11 is an enlarged sectional view of some components in FIG. 4.

FIG. 12 is an exploded view showing some components in FIG. 11.

FIG. 13 is a schematic view of another cylinder structure.

FIG. 14 is a schematic view of another cylinder structure and another inflation nozzle structure.

FIG. 15 is a structural view of some components in FIG. 2 from another viewing angle.

FIG. 16 is a partial enlarged view of part I in FIG. 4.

FIG. 17 is a partial sectional view of part of a cylinder in a nail gun in an example of the present application, showing a dustproof structure

FIG. 18 is a partial sectional view of another part of a cylinder in a nail gun in an example of the present application, showing a lubrication compensation assembly.

FIG. 19 is a partial sectional view of a nail gun in an example of the present application, showing a circuit board assembly and a second heat dissipation portion.

FIG. 20 is a structural view of some components in FIG. 19 from another viewing angle.

FIG. 21 is a partial sectional view of part of a cylinder in a nail gun in another example of the present application, where an adjustment assembly is in a second state.

FIG. 22 is a partial sectional view of part of a cylinder in a nail gun in another example of the present application, where an adjustment assembly is in a first state.

FIG. 23 is a partial perspective view of part of a cylinder in a nail gun in another example of the present application.

FIG. 24 is a schematic diagram of an electrical structure in any example of the present application.

### DETAILED DESCRIPTION

Before any examples of this application are explained in detail, it is to be understood that this application is not limited to its application to the structural details and the arrangement of components set forth in the following description or illustrated in the above drawings.

In this application, the terms “comprising”, “including”, “having” or any other variation thereof are intended to cover an inclusive inclusion such that a process, method, article or device comprising a series of elements includes not only those series of elements, but also other elements not expressly listed, or elements inherent in the process, method, article, or device. Without further limitations, an element defined by the phrase “comprising a . . . ” does not preclude the presence of additional identical elements in the process, method, article, or device comprising that element.

In this application, the term “and/or” is a kind of association relationship describing the relationship between associated objects, which means that there can be three kinds of relationships. For example, A and/or B can indicate that A exists alone, A and B exist simultaneously, and B exists alone. In addition, the character “/” in this application generally indicates that the contextual associated objects belong to an “and/or” relationship.

In this application, the terms “connection”, “combination”, “coupling” and “installation” may be direct connection, combination, coupling or installation, and may also be indirect connection, combination, coupling or installation. Among them, for example, direct connection means that two members or assemblies are connected together without intermediaries, and indirect connection means that two members or assemblies are respectively connected with at least one intermediate members and the two members or assemblies are connected by the at least one intermediate members. In addition, “connection” and “coupling” are not limited to physical or mechanical connections or couplings, and may include electrical connections or couplings.

In this application, it is to be understood by those skilled in the art that a relative term (such as “about”, “approximately”, and “substantially”) used in conjunction with quantity or condition includes a stated value and has a meaning dictated by the context. For example, the relative term includes at least a degree of error associated with the measurement of a particular value, a tolerance caused by manufacturing, assembly, and use associated with the particular value, and the like. Such relative term should also be considered as disclosing the range defined by the absolute values of the two endpoints. The relative term may refer to plus or minus of a certain percentage (such as 1%, 5%, 10%, or more) of an indicated value. A value that did not use the relative term should also be disclosed as a particular value with a tolerance. In addition, “substantially” when expressing a relative angular position relationship (for example, substantially parallel, substantially perpendicular), may refer to adding or subtracting a certain degree (such as 1 degree, 5 degrees, 10 degrees or more) to the indicated angle.

In this application, those skilled in the art will understand that a function performed by an assembly may be performed by one assembly, multiple assemblies, one member, or multiple members. Likewise, a function performed by a member may be performed by one member, an assembly, or a combination of members.

In this application, the terms “up”, “down”, “left”, “right”, “front”, and “rear” and other directional words are described based on the orientation or positional relationship shown in the drawings, and should not be understood as limitations to the examples of this application. In addition, in this context, it also needs to be understood that when it is mentioned that an element is connected “above” or “under” another element, it can not only be directly connected “above” or “under” the other element, but can also be indirectly connected “above” or “under” the other element through an intermediate element. It should also be understood that orientation words such as upper side, lower side, left side, right side, front side, and rear side do not only represent perfect orientations, but can also be understood as lateral orientations. For example, lower side may include directly below, bottom left, bottom right, front bottom, and rear bottom.

In this application, the terms “controller”, “processor”, “central processor”, “CPU” and “MCU” are interchangeable. Where a unit “controller”, “processor”, “central processing”, “CPU”, or “MCU” is used to perform a specific function, the specific function may be implemented by a single aforementioned unit or a plurality of the aforementioned unit.

In this application, the term “device”, “module” or “unit” may be implemented in the form of hardware or software to achieve specific functions.

In this application, the terms “computing”, “judging”, “controlling”, “determining”, “recognizing” and the like refer to the operations and processes of a computer system or similar electronic computing device (e.g., controller, processor, etc.).

To clearly illustrate technical solutions of the present application, an upper side, a lower side, a left side, a right side, a front side, and a rear side are defined in the drawings of the specification.

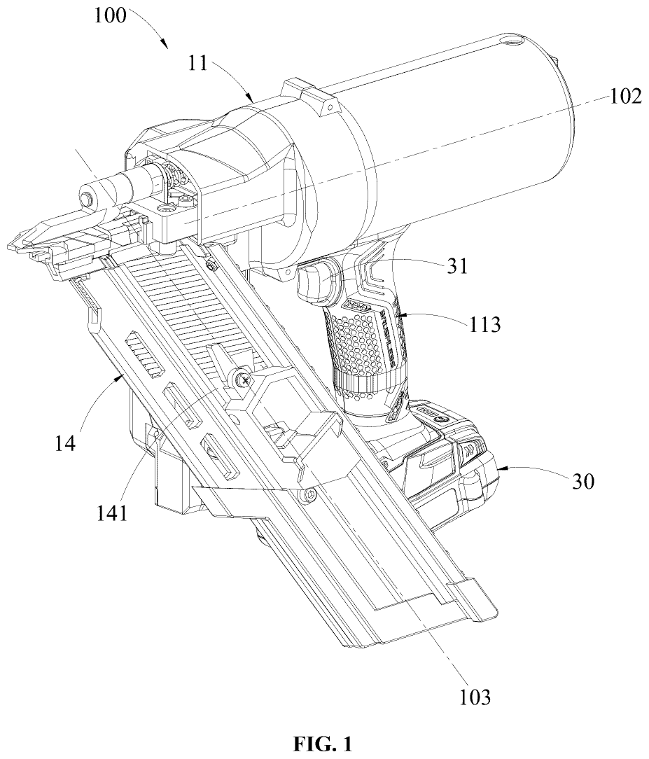

FIG. 1 shows a power tool in an example of the present application. In this example, the power tool is a nail gun 100. In some examples, the power tool may further include a glue gun, a stapler, or other gas spring power tools.

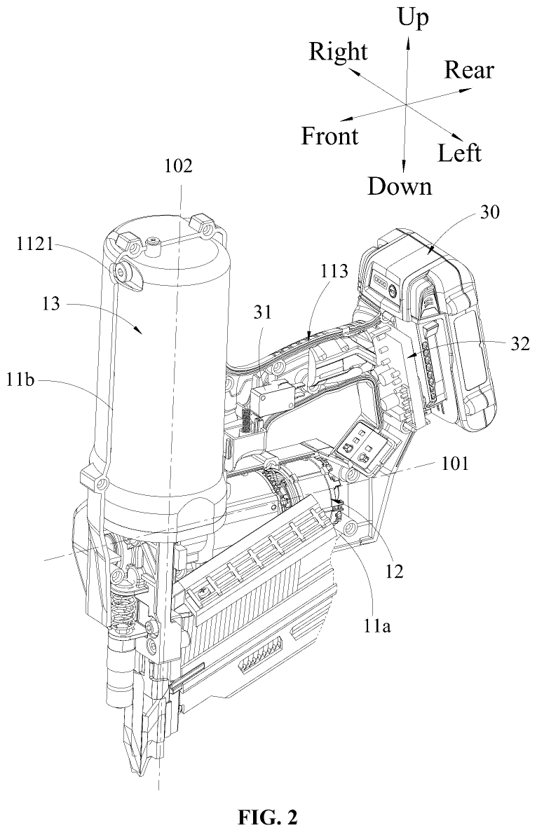

As shown in FIGS. 1 and 2, the nail gun 100 includes a housing 11, a power output portion 12, a cylinder 13, and a magazine assembly 14. The housing 11 includes a first accommodation space 11a formed and extending along a direction of a first straight line 101 and a second accommodation space 11b formed and extending along a direction of a second straight line 102. The power output portion 12 is disposed in the first accommodation space 11a, and the cylinder 13 is disposed in the second accommodation space 11b. The first straight line 101 intersects with the second straight line 102. In this example, the first straight line 101 and the second straight line 102 are substantially perpendicular to each other.

The housing 11 is further formed with a handle portion 113 for a user to hold. A power interface is connected to an end of the handle portion 113 and configured to connect a direct current power supply or an alternating current power supply. In this example, the nail gun 100 is powered by the direct current power supply. Optionally, the direct current power supply is a battery pack 30. Elements in the nail gun 100 are powered by the battery pack 30 in conjunction with a corresponding power supply circuit. The battery pack 30 is detachably connected to the handle portion 113. It is to be understood by those skilled in the art that the power supply is not limited to the battery pack 30, and circuit elements may also be powered by mains power, an alternating current power supply, or a combination of mains power and the battery pack 30 in conjunction with the corresponding rectifier circuit, filter circuit, and voltage regulator circuit.

A main switch 31 is disposed on the handle portion 113, and the user controls, through the main switch 31, the nail gun 100 to start or stop.

The magazine assembly 14 is disposed in a direction of a third straight line 103. Fasteners (for example, nails, tacks, or staples) are retained in the magazine assembly 14 so that the user is allowed to perform multiple fastening operations without manually reloading a fastener driver after each driving cycle. In some examples, the magazine assembly 14 can accommodate fasteners of different types or lengths.

As an optional example, the magazine assembly 14 is further provided with a window 141 for the user to view the remaining nails. The window 141 is configured to be one or more gaps on the magazine assembly 14. In one aspect, the user can check the number of the remaining nails through the window 141. In the other aspect, the user can perform simple maintenance on the magazine assembly 14 through the window 141 without detaching the magazine assembly 14.

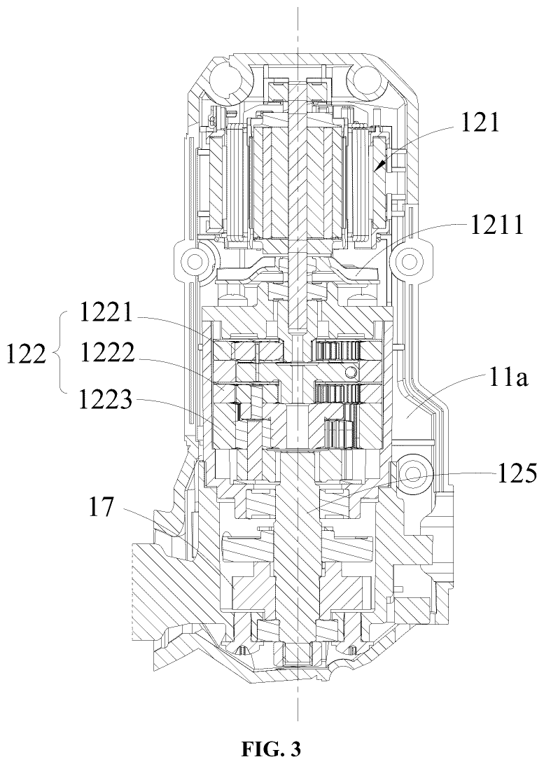

As shown in FIG. 3, the power output portion 12 includes a motor 121, a transmission assembly 122, an output shaft 125, and a driving member 17. In this example, the motor is specifically an electric motor 121. In the following description, the motor is replaced by the electric motor 121, which is not intended to limit the present application. The electric motor 121 can output power to the transmission assembly 122. After a speed shift of the transmission assembly 122, the power continues being outputted to the output shaft 125, and the driving member 17 is disposed on the output shaft 125. Specifically, the electric motor 121, the transmission assembly 122, the output shaft 125, and the driving member 17 are all distributed along the direction of the first straight line 101. A speed-shifting mechanism is disposed in the transmission assembly 122. In this example, the transmission assembly 122 includes a first planetary gear set 1221, a second planetary gear set 1222, and a third planetary gear set 1223. In some alternative examples, the transmission assembly further includes a back stopping assembly. The back stopping assembly is disposed in the transmission assembly 122 and is disposed at one end of the speed-shifting mechanism or an intermediate position of the speed-shifting mechanism. As an implementation, the back stopping assembly enables the output shaft 125 to output a driving force only along a first rotation direction and restricts the rotation of the output shaft 125 in a second rotation direction opposite to the first rotation direction.

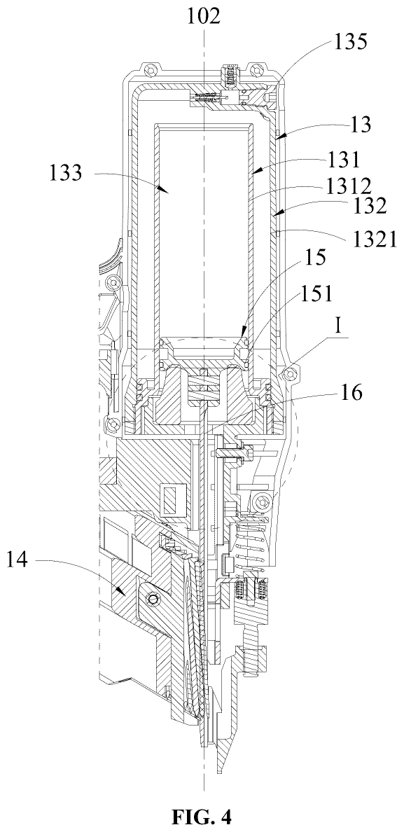

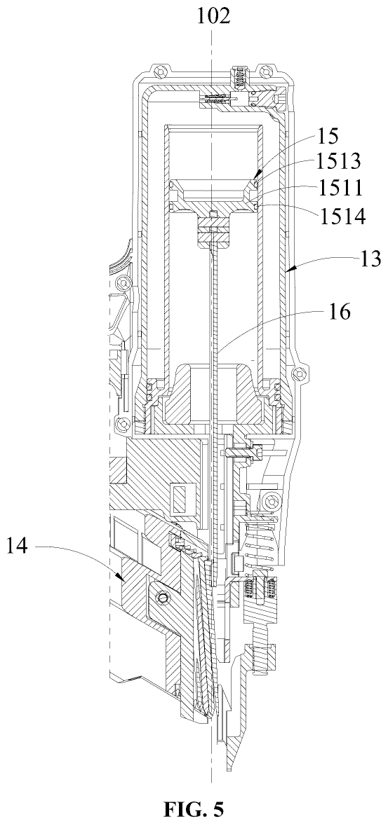

As shown in FIGS. 4 and 5, a firing assembly 15 is disposed in the cylinder 13 and works through gas in the cylinder 13. The gas in the cylinder 13 pushes the firing assembly 15 to move, so as to drive the fasteners (for example, the nails, the tacks, or the staples) retained in the magazine assembly 14 into a workpiece. In this example, the cylinder 13 further includes an inflation nozzle 135 configured to inflate the cylinder 13 with gas in advance.

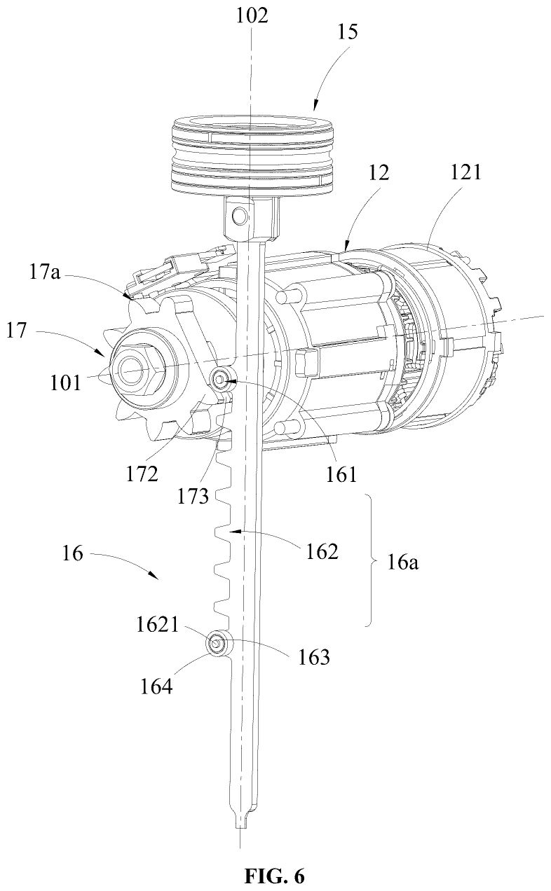

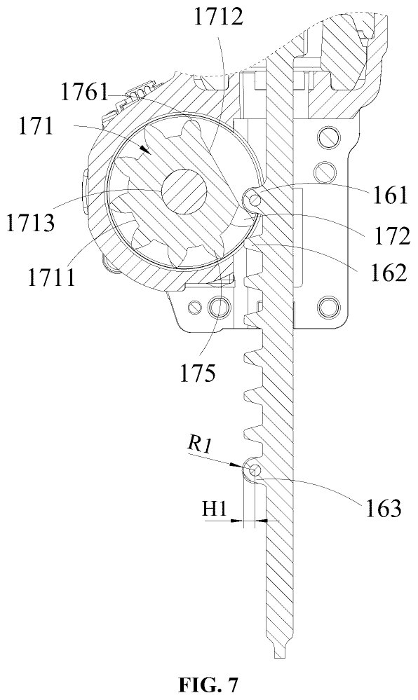

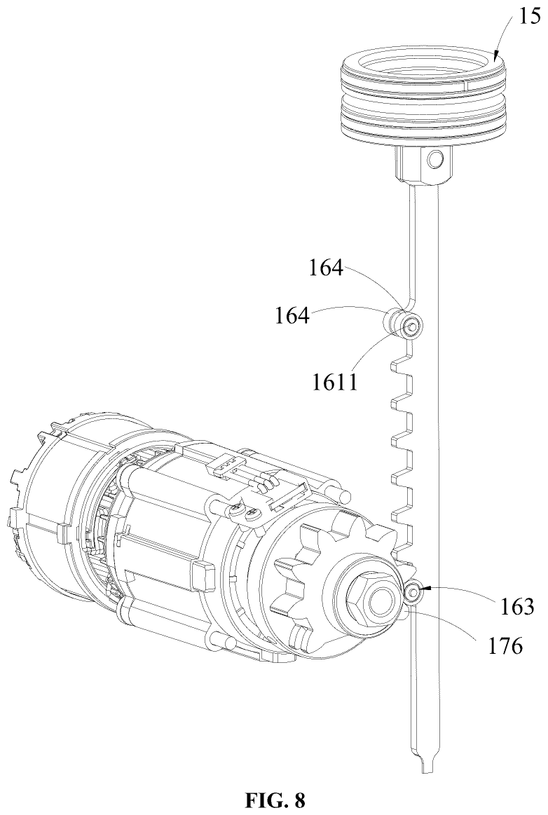

In one nailing cycle, the power output portion 12 drives the driving member 17 to rotate to drive the firing assembly 15 to move between a firing position (a bottom dead center, as shown in FIGS. 4, 6, and 7) and an energy storage position (a top dead center, as shown in FIGS. 5 and 8). The electric motor 121 is energized so that the driving member 17 drives the firing assembly 15 from the firing position to the energy storage position, and the firing assembly 15 compresses the gas in the cylinder 13. When the firing assembly 15 is at the energy storage position, the firing assembly 15 and the driving member 17 are retained in place, and the compressed gas continuously pushes the firing assembly 15 so that the firing assembly 15 has acceleration. Until a trigger instruction indicating that the user starts to drive a nail is received, a retaining force of the firing assembly 15 is released at this time. When the retaining force is released, the gas compressed by the firing assembly 15 drives the firing assembly 15 to the firing position, thereby driving the nail into the workpiece.

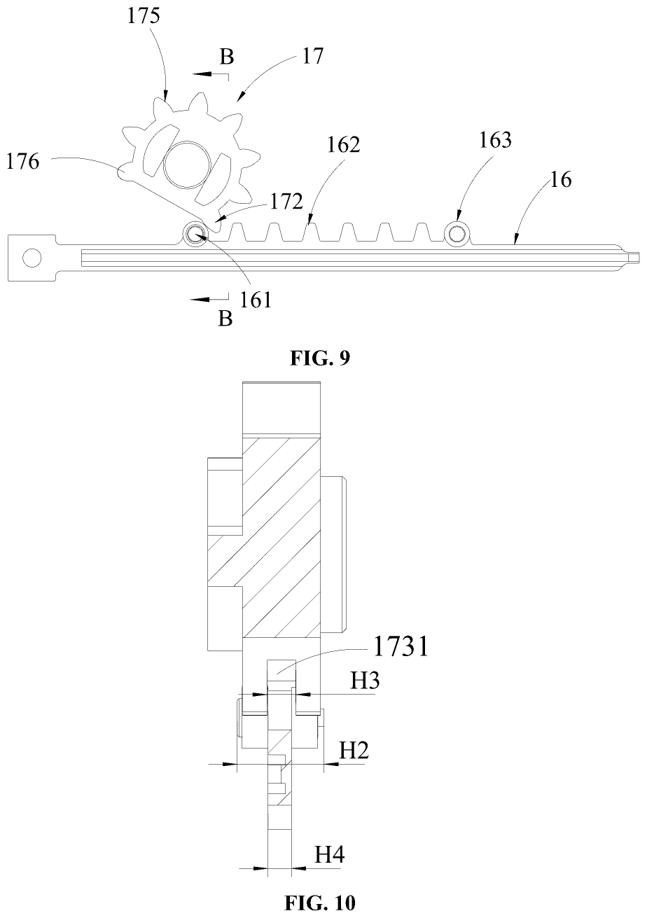

As shown in FIGS. 4 to 9, the firing assembly 15 includes a striker 16 and a piston 151. The striker 16 is disposed on the piston 151. The piston 151 is disposed in the cylinder 13 and driven by the power output portion 12 and moves in the cylinder 13 to compress the gas in the cylinder 13. The driving member 17 drives the striker 16 so that the piston 151 moves in the cylinder 13 along the direction of the second straight line 102, and the firing assembly 15 moves from the firing position to the energy storage position.

In this example, the striker 16 is provided with transmission teeth 16a, and the driving member 17 is provided with driving teeth 17a that mesh with the transmission teeth 16a. In some examples, the striker 16 and the driving member 17 are provided with protrusions and recesses that are in contact and mesh with each other. Optionally, the recesses may be slots, blind holes, or through-hole structures. Optionally, mating structures of the striker 16 and the driving member 17 may include magnetic attraction structures that attract each other and similar structures.

When the firing assembly 15 drives the nail out, the firing assembly 15 may fail to fully move to the firing position (the bottom dead center) for some reason. In a process where the firing assembly 15 continues moving, a collision between the striker 16 and the driving member 17 may be caused, thereby wearing the driving teeth 17a of the driving member 17 and/or the transmission teeth 16a on the striker 16. The “reasons” include: the workpiece into which the nail is driven is excessively hard so that a rebound force of the struck object, that is, the nail, causes the firing assembly 15 to rebound upward by a small distance from the firing position. Optionally, the “reasons” may further include: a striking force of the firing assembly 15 on the nail is insufficient so that the nail cannot enter the workpiece at a preset length, causing the striker 16 to fail to reach the bottom dead center position. In this case, if the driving member 17 is in contact with and meshes with the striker 16, tooth misalignment may occur between the striker 16 and the driving member 17 and cause a collision or jamming. To solve the preceding problem, the present application optimally designs the structures of the driving member 17 and the striker 16, thereby preventing the driving teeth 17a and the transmission teeth 16a from being worn by the collision between the striker 16 and the driving member 17.

In this example, the driving member 17 is configured to be a driving wheel using the first straight line 101 as a rotation axis. The driving member 17 includes a body portion 171 surrounding the driving member 17. The body portion 171 is formed with the multiple driving teeth 17a, and the driving teeth 17a include a first driving portion 172 provided at an initial end. The striker 16 is configured to be a rack using the second straight line 102 as a length direction. The striker 16 is provided with the transmission teeth 16a in a direction perpendicular to the second straight line 102. The transmission teeth 16a include a first lifting portion 161. The first driving portion 172 meshes with the first lifting portion 161 to cause the firing assembly 15 to start moving from the firing position to the energy storage position. It is to be understood that the first driving portion 172 is a first driving tooth of the driving member 17. The first lifting portion 161 is a first transmission tooth. When the driving member 17 starts driving the firing assembly 15 from the firing position to the energy storage position, the first driving portion 172 of the driving member 17 and the first lifting portion 161 of the striker 16 initially come into contact. It is to be explained that “the first driving portion 172 of the driving member 17 and the first lifting portion 161 of the striker 16 initially come into contact”, which means that the driving tooth 17a and the transmission tooth 16a that should initially come into contact when theoretical design is performed or the machine normally works are configured to be the first driving portion 172 and the first lifting portion 161, respectively. Situations that occur in fault states or abnormal states are not the contents of this section. The first driving portion 172 includes a first avoidance portion 173 configured to avoid a second lifting portion 162 below the first lifting portion 161. The second lifting portion 162 is configured to be a lifting portion other than the first lifting portion 161. In the present application, transmission teeth other than the first lifting portion 161 among the transmission teeth 16a are collectively referred to as second lifting portions 162. It is to be understood that one transmission tooth other than the first lifting portion 161 among the transmission teeth 16a may be considered as the second lifting portion 162, and it is not required that any transmission tooth other than the first lifting portion 161 is the second lifting portion 162.

When the firing assembly 15 fully moves to the firing position (the bottom dead center), the first driving portion 172, that is, the first driving tooth, is located between the first lifting portion 161 and one transmission tooth 16a among the second lifting portions 162. When the next nailing cycle begins, the first driving tooth 17a is in contact with and engaged with the first lifting portion 161, and then the first driving tooth 17a pushes the first lifting portion 161 to move upward. When the firing assembly 15 does not fully move to the firing position, whether the striker 16 rebounds or does not fall into place, the first driving tooth 17a is caused to be in contact with or collide with the second lifting portion 162. In the present application, the first driving portion 172 is provided with the first avoidance portion 173 capable of avoiding the second lifting portion 162. The first avoidance portion is configured to cause the second lifting portion to penetrate through or pass the first driving portion along a movement direction of the firing assembly. Thus, the collision or wear between the first driving portion 172 and the second lifting portion 162 is avoided, thereby prolonging service lives of the driving member 17 and the striker 16 and further prolonging a service life of the nail gun 100 and use safety of the nail gun 100.

The driving member 17 is further formed with a connection hole 1713 which can be connected to the output shaft 125. When the output shaft 125 is connected to the connection hole 1713, the driving member 17 can rotate synchronously with the output shaft 125. The driving member 17 further includes a second driving portion 175, and the second driving portion 175 is configured to be a driving portion other than the first driving portion 172. In the present application, driving teeth 17a other than the first driving portion 172 among the driving teeth 17a are collectively referred to as second driving portions 175. The first driving portion 172 and the second driving portions 175 are uniformly distributed in a first section 1711 of the driving member 17. The second driving portions 175 mesh with the second lifting portions 162 below the first lifting portion 161. To ensure that the driving member 17 and the striker 16 mesh with each other stably, no first avoidance portion 173 is provided on the second driving portion 175. An axial direction of the driving member 17 is defined as a width direction of the driving member 17, and a width of the second driving portion 175 is substantially the same as a width of the first driving portion 172.

The driving member 17 further includes a second section 1712. The second section 1712 is smooth and continuous, and no driving tooth 17a is distributed in the second section 1712. As shown in FIG. 8, when the driving teeth 17a in the first section 1711 mesh with the transmission teeth 16a on the striker 16, the driving member 17 can drive the striker 16 so that the piston 151 compresses the gas in the cylinder 13 to work. When the second section 1712 mates with the striker 16, since the second section 1712 is smooth and continuous, the striker 16 is quickly pushed out by the gas in the cylinder 13 in a case where the striker 16 is not stopped by the driving teeth 17a, thereby achieving a nailing effect.

As shown in FIGS. 8 to 10, a width H2 of the first lifting portion 161 is greater than a width H3 of the first avoidance portion 173, and a width H4 of the second lifting portion 162 is less than or equal to the width H3 of the first avoidance portion 173. That is to say, the width of the first lifting portion 161 is greater than the width of the second lifting portion 162. In this example, the first avoidance portion 173 is configured to be a groove 1731 that is on the first driving portion 172 and extends along the movement direction of the firing assembly 15. That is to say, the first avoidance portion 173 is the groove 1731 extending along the direction of the second straight line 102 and using the direction of the second straight line 102 as a length direction. The groove 1731 penetrates through the first driving portion 172 along a circumferential direction of the second straight line 102. An opening is provided on a side of the groove 1731 close to the first lifting portion 161, so as to form an avoidance passage configured to allow the second lifting portion 162 to pass along the movement direction of the firing assembly (in this example, the movement direction of the firing assembly is an up and down direction).

In some examples, the first avoidance portion 173 may be a shortened or thinned portion of the first driving portion 172. That is to say, according to different specific structures of the driving member 17 and the striker 16, the specific structure of the first avoidance portion may be designed accordingly for adaptation. Therefore, the structure of the first avoidance portion 173 that enables the second lifting portion 162 to be avoided by the first driving portion 172 belongs to content that conforms to a basic principle and main features of the present application.

In this example, the first lifting portion 161 includes a second rotary shaft 1611. Rollers 164 are disposed on the second rotary shaft 1611, and the rollers 164 rotate about a second rotation axis. The second rotary shaft 1611 is fixedly connected to or integrally formed with the first lifting portion 161. The second rotary shaft 1611 is disposed on two sides of a tooth surface of the tooth of the first lifting portion 161, and the rollers 164 can freely rotate around the second rotary shaft 1611. The rollers 164 are disposed on the two sides of the tooth of the first lifting portion 161 to ensure the width of the position of the first lifting portion 161.

The striker 16 further includes a third lifting portion 163. The first lifting portion 161, the second lifting portion 162, and the third lifting portion 163 are sequentially provided at increasing distances from the piston 151. In the preceding nailing cycle, the driving member 17 rotates about a first direction to drive the firing assembly 15 to move, and until the last tooth among the driving teeth 17a on the driving member 17 meshes with the lowermost transmission tooth 16a among the transmission teeth 16a, the firing assembly 15 is located at the energy storage position. That is to say, when the last tooth among the driving teeth 17a meshes with the lowermost tooth among the transmission teeth 16a, the firing assembly 15 is located at the top dead center position. In this case, the firing assembly 15 and the driving member 17 are retained in place, and the nail gun 100 enters a ready-to-fire stage. In this case, the retaining force of the firing assembly 15 is released, that is, the driving member 17 continues rotating and then rotates to the second section 1712. In this case, the driving tooth 17a is disengaged from the transmission tooth 16a. The third lifting portion 163 is configured to be the lowermost tooth of the striker 16. A tooth on the driving member 17 that is in contact with and meshes with the third lifting portion 163 is a third driving portion 176. When the nail gun 100 is in the ready-to-fire stage, that is, the firing assembly 15 and the driving member 17 are retained in place, the third driving portion 176 and the third lifting portion 163 keep meshing with each other through only one contact surface, which is not inter-tooth meshing in real sense. In this case, the third lifting portion 163 needs to bear an acting force accumulated in the cylinder 13 in a ready-to-fire state of the nail gun 100, and at a firing moment when the acting force is released, the third driving portion 176 and the third lifting portion 163 further have a rolling friction process. Therefore, wear of the third lifting portion 163 is further increased. To reduce the wear of the third lifting portion 163, a rolling friction member is disposed on the third lifting portion 163.

In this example, the third lifting portion 163 includes a first rotary shaft 1621. A roller 164 is disposed on the first rotary shaft 1621, and the roller 164 rotates about a first rotation axis. A radius R1 of the roller 164 is greater than or equal to a length H1 of a connection line between a tooth top of the tooth of the third lifting portion 163 and a shaft center of the first rotary shaft 1621. A wall surface of the third driving portion 176 in contact with the roller 164 is a smooth surface 1761. The first rotary shaft 1621 is fixedly connected to or integrally formed with the third lifting portion 163. The first rotary shaft 1621 is disposed on two sides of a tooth surface of the tooth of the third lifting portion 163, and the roller 164 can freely rotate around the first rotary shaft 1621. When the nail gun 100 is in the ready-to-fire state, the third driving portion 176 actually meshes with the roller 164 and generates an acting force by squeezing the roller 164. When the nail gun 100 is caused to be in a firing state, rolling friction is generated between the third driving portion 176 and the roller 164, thereby greatly reducing an interaction force between the third driving portion 176 and the roller 164 and alleviating the wear of the third lifting portion 163.

For mounting of the striker 16 and the piston 151, in this example, the piston 151 includes a metal member 1511, a first rubber ring 1513, and a second rubber ring 1514. The metal member 1511 is configured to be a body structure of the piston 151 to support the overall structure of the piston 151 and provide sufficient strength. The striker 16 is fixed on the metal member 1511. The first rubber ring 1513 and the second rubber ring 1514 are sleeved outside the metal member 1511. The first rubber ring 1513 and the second rubber ring 1514 are in contact with an inner wall of the cylinder 13 separately. It is to be understood that the first rubber ring 1513 and the second rubber ring 1514 form a seal with the inner wall of the cylinder 13 separately to implement the function of compressing the piston 151.

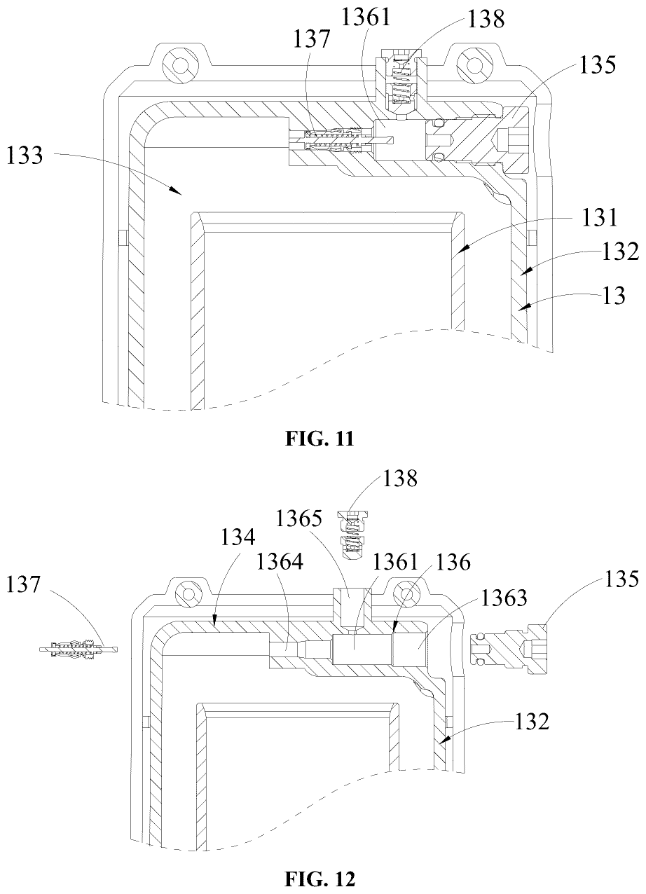

As shown in FIGS. 4, 11, and 12, the cylinder 13 includes a cylinder barrel portion 133 configured to store the gas. The cylinder barrel portion 133 is provided with a chamber, where the gas is stored in the chamber. The piston 151 moves in the cylinder barrel portion 133 to compress the gas to work. The cylinder 13 is inflated with the gas in advance through the inflation nozzle 135. Therefore, an external air pressure source is not required. In this example, the cylinder 13 further includes an inflation valve 137 and a pressure relief valve 138. The gas filled through the inflation nozzle 135 flows through the inflation valve 137 and then enters the cylinder 13 (the chamber of the cylinder barrel portion 133). The pressure relief valve 138 is disposed between the inflation nozzle 135 and the inflation valve 137. It is to be understood that the pressure relief valve 138 allows one-way flow and restricts the gas from entering the cylinder 13. The one-way pressure relief valve 138 is disposed on an inflation downstream side of the inflation nozzle 135. The one-way pressure relief valve communicates with an outside of the cylinder for an escape of the gas. When a pressure of the gas filled through the inflation nozzle 135 is greater than a first preset pressure, the filled gas is released through the one-way pressure relief valve 138. When the cylinder 13 is inflated with the gas in advance, the cylinder 13 may be damaged if the pressure of the filled gas is excessively large. Therefore, the pressure relief valve 138 is first disposed behind the inflation nozzle 135 so that when the pressure of the filled gas is greater than the first preset pressure, the gas is released to the outside, thereby protecting the cylinder 13 and preventing the gas with the excessively large pressure entering the chamber of the cylinder barrel portion 133.

In this example, the pressure relief valve 138 is disposed in the cylinder 13.

In this example, the inflation valve 137 allows one-way flow. The inflation valve 137 restricts the gas in the cylinder 13 from flowing out of the cylinder 13 through the inflation valve 137.

In this example, the inflation valve 137 is configured to be a valve core structure. The valve core structure includes an English valve needle, an American valve core, a French valve core, a German valve needle, and an Italian valve core. The preceding specific structure of the inflation valve 137 does not limit the essence of the present application. The inflation valve 137 restricts the gas from entering the chamber of the cylinder 13 when a gas pressure in the chamber of the cylinder 13 is greater than a second preset pressure. This configuration aims to prevent the chamber of the cylinder 13 from having an excessive internal gas pressure and resulting in a difficulty in the gas compression of the piston 151 or damage to the cylinder 13 during the gas compression.

A value of the first preset pressure and a value of the second preset pressure are adjusted and adaptively set according to requirements of a specific product. In some examples, the first preset pressure is less than the second preset pressure. Optionally, the first preset pressure is equal to the second preset pressure.

The cylinder 13 further includes an inflation portion 136, and the inflation portion 136 is connected to the chamber of the cylinder barrel portion 133 through the inflation valve 137. The inflation portion 136 includes a gas passage portion 1361, the inflation nozzle 135 and the inflation valve 137 are disposed at two ends of the gas passage portion 1361, and the pressure relief valve 138 is disposed on the gas passage portion 1361. When the pressure relief valve 138 and the inflation valve 137 are in a closed state, a gas pressure in the gas passage portion is greater than or equal to atmospheric pressure. The gas passage portion 1361 forms a second gas chamber. The second gas chamber has a certain length. The pressure relief valve 138 releases the gas along a direction intersecting with a length direction of the second gas chamber.

The cylinder 13 is configured to be a structure having an inner cylinder body and an outer cylinder body. It is to be understood that the cylinder barrel portion 133 has an inner cylinder 131 and an outer cylinder 132 disposed around the inner cylinder 131. The outer cylinder 132 is configured to be a cylindrical structure having an opening portion and has an annular outer wall 1321. A chamber is formed in the outer cylinder 132. A chamber of the inner cylinder 131 enclosed by an annular inner wall 1312 is configured in the chamber of the outer cylinder 132. The chamber of the inner cylinder 131 communicates with the chamber of the outer cylinder 132. The annular inner wall 1312 is configured to guide a movement of the piston 151 along the second straight line 102 to compress the gas.

It is to be understood that when the double-layer cylinder 13 is provided, gas in the inner cylinder communicates with gas in the outer cylinder. In a process where the firing assembly 15 provided in the inner cylinder 131 is driven to compress the gas or is driven by the working gas, a contact area between the firing assembly 15 and the gas in the cylinder 13 is relatively small so that a variation value of the gas pressure in the cylinder 13 is relatively small. Thus, a striking force outputted by the gas in the cylinder 13 is relatively stable, which causes the nail gun 100 to provide better operation experience.

In this example, the outer cylinder 132 and the inner cylinder 131 are arranged concentrically.

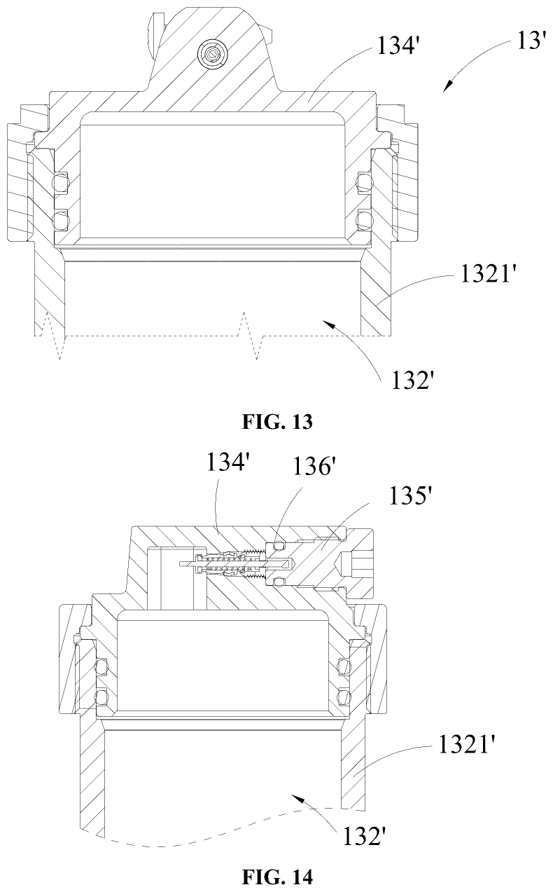

In this example, the inflation portion 136 is disposed on the outer cylinder 132. The inflation nozzle 135, the inflation valve 137, and the pressure relief valve 138 are disposed on the outer cylinder 132 separately. As shown in FIG. 12, an end of a closed cylinder bottom 134 of the outer cylinder 132 and the annular outer wall 1321 are integrally formed. In some examples, as shown in FIGS. 13 and 14, a cylinder bottom 134′ and an annular outer wall 1321′ are separate components and are sealingly connected to each other through a fastener and a sealing member. As an alternative example, as shown in FIG. 14, an inflation nozzle 135′ is configured to restrict the gas from being released from the inflation nozzle 135′ and flowing out of the cylinder.

The inflation portion 136 is disposed at the cylinder bottom 134 or near the cylinder bottom 134. The inflation portion 136 is formed at the cylinder bottom 134 and located in the chamber of the outer cylinder 132. Optionally, the inflation portion 136 is provided with three mounting ports. A first mounting port 1363 is configured to allow the inflation nozzle 135 to enter the inflation portion 136. A second mounting port 1364 is configured to allow the inflation valve 137 to enter the inflation portion 136. A third mounting port 1365 is configured to allow the pressure relief valve 138 to enter the inflation portion 136. The third mounting port 1365 is located between the first mounting port 1363 and the second mounting port 1364. Two ends of the gas passage portion 1361 are the first mounting port 1363 and the second mounting port 1364, respectively. It is to be understood that the first mounting port 1363 communicates with the outside and the gas passage portion 1361. The second mounting port 1364 connects the gas passage portion 1361 to the chamber of the outer cylinder 132. An extension axis of the third mounting port 1365 intersects with an extension axis of the gas passage portion 1361, that is, an extension axis of the second gas chamber 1362. When the pressure relief valve 138 and the inflation valve 137 are in the closed state, and the inflation nozzle 135 is also in a closed state, the gas passage forms a closed chamber, that is, no gas flows in the second gas chamber 1362. In some examples, if the inflation nozzle 135 is in a normally open state, the cylinder 13 retains the gas through the inflation valve 137. Then, the gas passage is in a state of communicating with the atmosphere, and the gas flows between the second gas chamber 1362 and the outside atmosphere. Therefore, when the pressure relief valve 138 and the inflation valve 137 are in the closed state, the gas pressure in the gas passage is greater than or equal to the atmospheric pressure.

As shown in FIGS. 13 and 14, in some alternative examples, a cylinder 13′ may be provided with only one layer of cylinder, that is, only an outer cylinder 132′. An inflation portion 136′ is disposed on the outer cylinder 132′.

As shown in FIGS. 2, 15, and 16, the second housing 112 forms the second accommodation space 11b. The second housing 112 supports the cylinder 13. Optionally, the outer cylinder 132 is at least partially positioned in the second housing 112. The second housing 112 includes an inflation hole 1121 corresponding to the inflation nozzle 135. That is, the inflation nozzle 135 is exposed to the outside through the inflation hole 1121. A retaining member 19 is configured to fix the cylinder 13. The retaining member 19 includes a positioning portion 191. The positioning portion 191 is configured to fix the cylinder 13 at a preset position causing the inflation nozzle 135 to correspond to the inflation hole 1121. The positioning portion indicates a position where the inflation nozzle is assembled with the inflation hole, so as to ensure that the assembly is performed at a position of the inflation nozzle 135 in a defined orientation. The positioning portion 191 is used by an assembler to determine a mounting direction and a positioning direction, thereby facilitating position determination.

The positioning portion 191 includes a first indicating structure 1911 disposed on the retaining member 19. The cylinder 13 is provided with a second indicating structure 1912. When the first indicating structure 1911 and the second indicating structure 1912 meet a preset relationship, a position of the cylinder 13 meets the preset position. In this example, each of the first indicating structure 1911 and the second indicating structure 1912 is configured to be a flat mechanism. When the two flat mechanisms are aligned and the cylinder 13 is mounted in the second housing 112, the position of the inflation nozzle 135 is aligned with a position of the inflation hole 1121, and the assembler does not need to perform adjustment repeatedly to align the position of the inflation nozzle 135 with the position of the inflation hole 1121.

In some examples, the first indicating structure 1911 and the second indicating structure 1912 are configured to be notches, protrusion and recess mating structures, pin and slot mating, or similar visible structures capable of indicating proper assembly, respectively. Alternatively, proper assembly is indicated through sound and a stop structure.

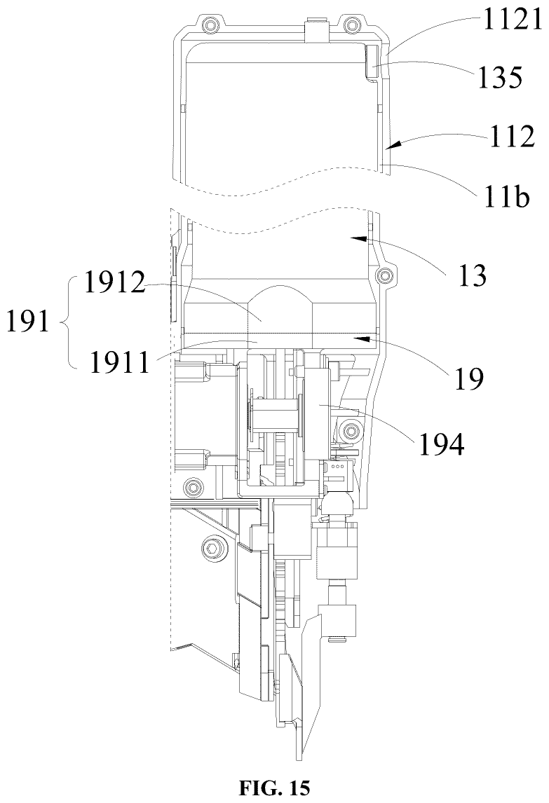

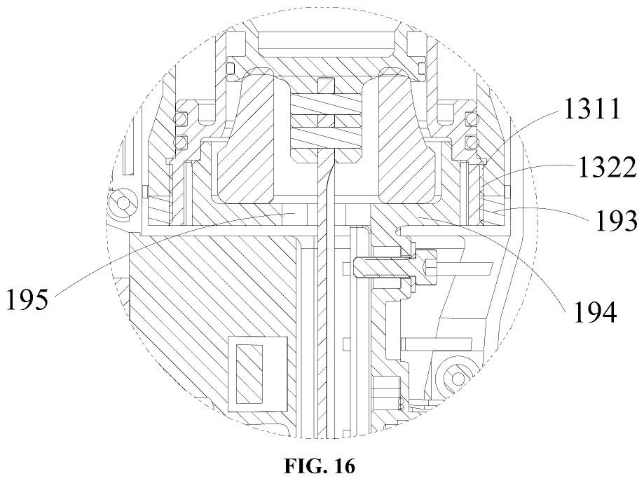

As shown in FIGS. 15 and 16, the retaining member 19 is configured to connect the inner cylinder 131 to the outer cylinder 132. Optionally, the inner cylinder 131 is rotatably connected to the outer cylinder 132, and the positioning portion 191 indicates a rotation ending point of the outer cylinder 132. As an example, the retaining member 19 includes a first threaded segment 1311 provided on an outer sidewall of the inner cylinder 131 and a second threaded segment 1322 provided on an inner sidewall of the outer cylinder 132, and the first threaded segment 1311 meshes with the second threaded segment 1322. When the first indicating structure 1911 is aligned with the second indicating structure 1912, the first threaded segment 1311 rotationally meshes with the second threaded segment 1322 in place. In this example, the retaining member 19 further includes a retaining ring 193 disposed on an outer side of the outer cylinder 132, and the retaining ring 193 restricts loosening of the meshing between the first threaded segment 1311 and the second threaded segment 1322. Optionally, the first indicating structure 1911 is formed on or connected to the retaining ring 193.

The retaining member 19 further includes a support base 194 connected to the cylinder 13. The support base 194 is configured to fix the inner cylinder 131 and position the inner cylinder 131 and the housing 11. The support base 194 is formed with a first through hole 195 through which the firing assembly 15 can penetrate. An opening of the cylinder 13 through which the piston 151 can pass communicates with the first through hole 195, that is, after the cylinder 13 is connected to the support base 194, the cylinder 13 and the support base 194 form a through whole. Thus, the piston 151 can move within this through range. The cylinder 13 communicates with the support base 194 to form a whole, and the whole is bounded by the piston 151 and includes a first space and a second space. The first space is a relatively closed space formed by an end of the piston 151 close to the cylinder 13. The second space is a relatively open space formed by an end of the piston 151 close to the support base 194. In an alternative example, the first indicating structure 1911 is formed on or connected to the support base 194.

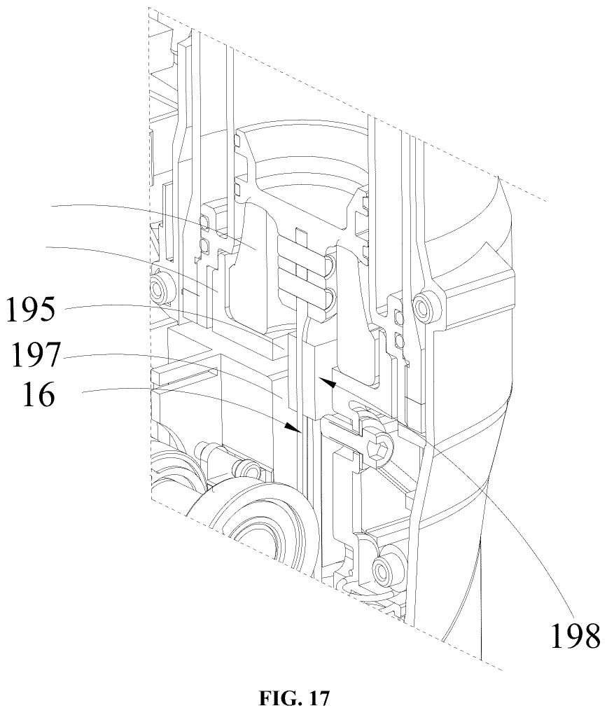

As an alternative example, as shown in FIG. 17, the cylinder 13 further includes a dustproof portion 198. The dustproof portion 198 is disposed at a position where the striker 16 extends out of the cylinder 13, so as to restrict dust on the striker 16 from entering the cylinder 13. Optionally, the dustproof portion 198 is disposed near the first through hole 195 or in the first through hole 195. Optionally, a cushion 196 is further disposed on the support base 194. When the piston 151 moves to the support base 194 at a high speed, the piston 151 is in contact with the cushion 196 and can counteract part of kinetic energy, thereby avoiding damage to the piston 151 or the support base 194 caused by a direct collision between the piston 151 and the support base 194. The dustproof portion 198 is disposed on the striker 16 and placed in a space formed by the cushion 196. Optionally, a firing channel 197 is connected to the support base 194, a gap is provided between a side of the firing channel 197 close to the piston 151 and the cushion 196, and the dustproof portion 198 is disposed in the preceding gap space. Optionally, the dustproof portion 198 includes a deformable component such as a felt pad, a rubber pad, or a silicone pad and is configured to passively prevent the dust on the striker 16 from entering the cylinder 13. Optionally, the dustproof portion 198 includes a magnetic attraction component and an electrostatic adsorption component and is configured to actively adsorb dust and prevent the dust from entering the cylinder 13.

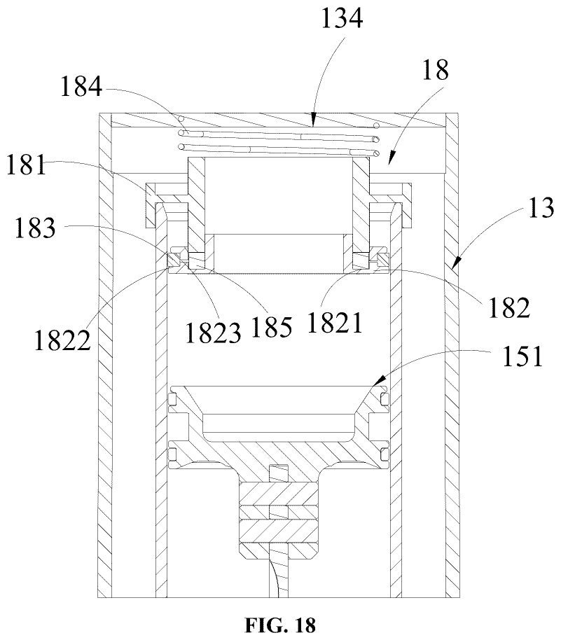

To ensure lubrication of the piston 151 and the cylinder 13, a lubricating substance is provided between the piston 151 and the cylinder 13 to reduce friction, wear, and loss of work performed by the gas. Since the assembled cylinder 13 is a sealed structure, as usage time increases, loss of the lubricating substance may be caused by the movement of the piston 151, resulting in wear of the cylinder 13 and the piston 151 and damage to sealing performance of the cylinder 13. As an optional example of this example, as shown in FIG. 18, a lubrication compensation assembly 18 is disposed in the cylinder 13 to compensate for the loss of the lubricating substance in a working process. The lubrication compensation assembly 18 includes a first retainer 181, a second retainer 182, and a grease storage portion 183. The first retainer 181 is connected to an end of the cylinder 13 and is used for retaining coupling between the lubrication compensation assembly 18 and the cylinder 13. The second retainer 182 is formed on or connected to the first retainer 181. The second retainer 182 is provided with a first groove 1821 configured to store grease 185. A second groove 1822 is formed on a side of the second retainer 182 facing the inner wall of the cylinder 13, and the second groove 1822 accommodates the grease storage portion 183. The first groove 1821 and the second groove 1822 are connected to each other through an oil outlet passage 1823. In this example, the grease storage portion 183 includes a porous medium. The porous medium is annular and disposed around the second retainer 182. In this example, an elastic element 184 is disposed on the first retainer 181. A certain gap is provided between the piston 151 and the lubrication compensation assembly 18. In this example, the lubrication compensation assembly 18 is disposed at the cylinder bottom 134 of the cylinder 13. In a process where the piston 151 compresses the gas, the lubrication compensation assembly 18 moves toward the cylinder bottom 134 of the cylinder 13 along with the movement of the piston 151, thereby compressing the elastic element 184. When the gas in the cylinder 13 releases energy to push the piston 151, the lubrication compensation assembly 18 is pushed by the elastic element 184 so that the lubrication compensation assembly 18 releases the lubricating grease on the inner wall of the cylinder 13 as uniformly as possible.

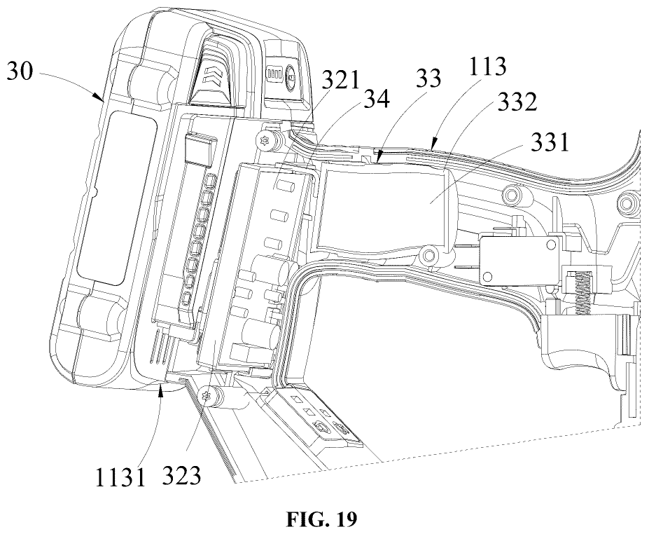

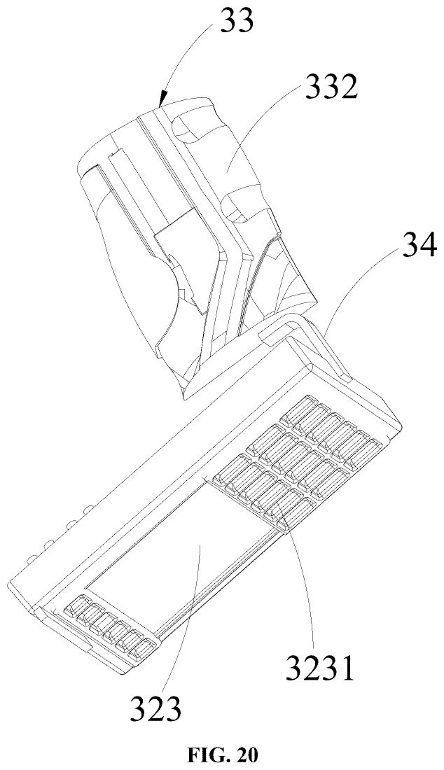

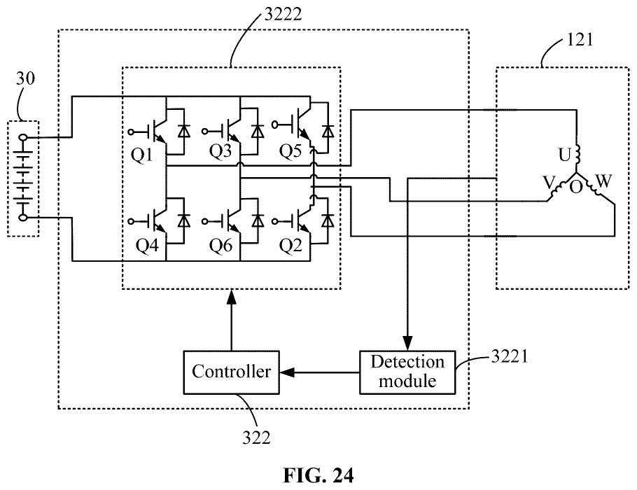

As shown in FIGS. 2, 19, 20, and 24, the nail gun 100 further includes a circuit board assembly 32 and a driver circuit 3222. The electric motor 121 is a brushless direct current motor. The circuit board assembly 32 is electrically connected to the electric motor 121 to control the electric motor 121. The circuit board assembly 32 includes a circuit board body 321, a controller 322, a first heat dissipation portion 323, and a detection module 3221. The circuit board body 321 includes a printed circuit board (PCB) and a flexible printed circuit (FPC) board. The controller 322 uses a dedicated control chip, for example, a single-chip microcomputer and a microcontroller unit (MCU). The controller 322 is disposed on the circuit board body 321.

The driver circuit 3222 is electrically connected to stator windings U, V, and W of the electric motor 121. The driver circuit 3222 is configured to transmit a current from the battery pack 30 to the stator windings U, V, and W, so as to drive the electric motor 121 to rotate. In an example, the driver circuit 3222 includes multiple switching elements Q1, Q2, Q3, Q4, Q5, and Q6. A gate terminal of each switching element is electrically connected to the controller 322 and is configured to receive a control signal from the controller 322. A drain or source of each switching element is connected to the stator windings U, V, or W of the electric motor 121. The switching elements Q1 to Q6 receive control signals from the controller 322 to change their respective on states, thereby changing a current loaded by the battery pack 30 to the stator windings U, V, and W of the electric motor 121. In an example, the driver circuit 3222 may be a three-phase bridge driver circuit including six controllable semiconductor power devices (such as field-effect transistors (FETs), bipolar junction transistors (BJTs), or insulated-gate bipolar transistors (IGBTs)). It is to be understood that the preceding switching elements may be any other types of solid-state switches, such as insulated-gate bipolar transistors (IGBTs) or bipolar junction transistors (BJTs).

Specifically, the controller 322 controls on or off states of the switching elements in the driver circuit 3222 through the control chip. The control chip controls the switching elements in the driver circuit 3222 to be in the on or off states according to the control signals from the controller 322. In some examples, the control signals from the controller 322 are pulse-width modulation (PWM) control signals.

In a process where the controller 322 controls a running state of the electric motor 121, the controller 322 generates a temperature rise. Since electronic devices on the circuit board body 321 are highly sensitive to temperatures, an excessive temperature rise without timely heat dissipation not only affects control efficiency of the controller 322, but may also damage the devices on the circuit board body 321. In this example, the nail gun 100 is further provided with a second heat dissipation portion 33 in addition to the first heat dissipation portion 323 of the circuit board assembly 32. The second heat dissipation portion 33 is disposed outside the circuit board assembly 32. In addition, the nail gun 100 is further provided with a heat conduction portion 34. The heat conduction portion 34 connects the circuit board assembly 32 to the second heat dissipation portion 33 so that the circuit board assembly 32 and the second heat dissipation portion 33 are in thermal contact. The second heat dissipation portion 33 includes a core 331 having a heat storage capability and a housing portion 332 having a heat dissipation capability. The core 331 is configured to undergo a phase transition reaction at a preset temperature to cool the housing portion 332.

In this example, the core 331 includes a phase transition material. The phase transition material is configured to at least partially melt at a preset temperature. In some examples, the preset temperature is determined according to a temperature change of the first heat dissipation portion. In some examples, the preset temperature is determined according to a difference between a temperature of the first heat dissipation portion and a maximum temperature that the circuit board body 321 can withstand. Optionally, the preset temperature is configured to be lower than the temperature of the first heat dissipation portion. Optionally, the preset temperature is configured to be lower than a temperature of the housing portion 332 when the nail gun 100 is at a high power consumption output so that the housing portion 332 is cooled. Cases where the nail gun 100 is at the high power consumption output include working states, such as those in which the nail gun 100 is at high output power (the nail gun 100 works at nominal output power or higher output power), a high speed (a nominal maximum rotational speed or a higher rotational speed), and a high load (a nominal output striking force or a greater output striking force).

The housing portion 332 includes a metal material. In some examples, the housing portion 332 includes other heat dissipation materials and heat conduction materials. The housing portion 332 forms an openable sealed chamber, and the core 331 is accommodated in the sealed chamber. That is to say, the phase transition material is sealingly accommodated in the housing portion 332. The phase transition material rapidly absorbs heat on the housing portion 332 through a phase transition from a solid state to a liquid state and gradually releases heat through a phase transition from the liquid state to the solid state when the nail gun 100 stops working or an ambient temperature decreases. A solid-liquid state conversion process of the phase transition material occurs in the sealed chamber, thereby preventing leakage of the phase transition material. The phase transition material forms a heat absorption process through conversion from the solid state to the liquid state and stores the heat and forms a heat storage and heat dissipation process in a process of converting from the liquid state to the solid state. The second heat dissipation portion 33 is added to assist the first heat dissipation portion 323 in dissipating the heat so that a heat dissipation capability is improved. Then, a working capability of the nail gun 100 can be further improved. In addition, the phase transition material has a heat storage capability, which is equivalent to energy recovery in a heat dissipation process. The heat storage and heat dissipation process is performed through the phase transition reaction, which achieves a more uniform melting and heat dissipation effect of the phase transition material than a manner of adding a fan 1211 or increasing power of a fan 1211. Moreover, the problems of relatively large noise and increase of a load of the electric motor 121 are avoided.

In this example, a battery mounting portion 1131 is disposed on the handle portion 113. The battery mounting portion 1131 is configured to be detachably connected to the battery pack 30. The circuit board assembly 32 is disposed in the housing 11 of the battery mounting portion 1131. The fan 1211 is connected to the electric motor 121. When the electric motor 121 starts, the fan 1211 rotates to generate a heat dissipation airflow. The first heat dissipation portion 323 is configured to be a circuit board housing for accommodating the circuit board body 321. In some examples, the circuit board housing is made of a metal material for heat dissipation. The circuit board housing is further provided with a fin structure 3231. In some examples, a phase transition material is also disposed in the first heat dissipation portion 323 to improve the heat dissipation capability.

The second heat dissipation portion 33 is disposed in the handle portion 113. In this example, a shape of an outer side of the housing portion 332 is adapted to an inner wall of a housing of the handle portion 113. Optionally, the outer side of the housing portion 332 substantially completely fits snugly around the inner wall of the housing of the handle portion 113.

To transfer heat between the circuit board assembly 32 and the second heat dissipation portion 33, the heat conduction portion 34 includes a metal material. The heat conduction portion 34 connects the first heat dissipation portion 323 to the housing portion 332 so that heat that cannot be released by the first heat dissipation portion 323 is transferred to the second heat dissipation portion 33, and the second heat dissipation portion 33 is used for assisting in the heat dissipation.

In this example, the second heat dissipation portion 33 may also assist a heat generation component that can release heat during work, such as the electric motor 121, the transmission assembly 122, or the cylinder 13, in dissipating the heat.

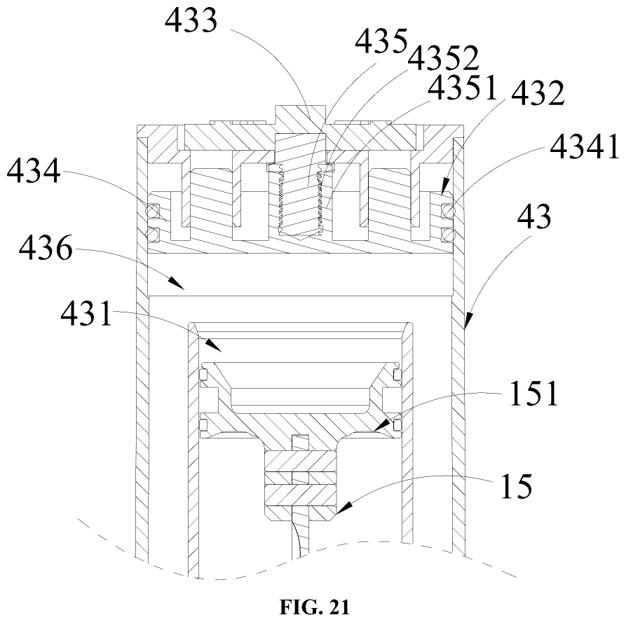

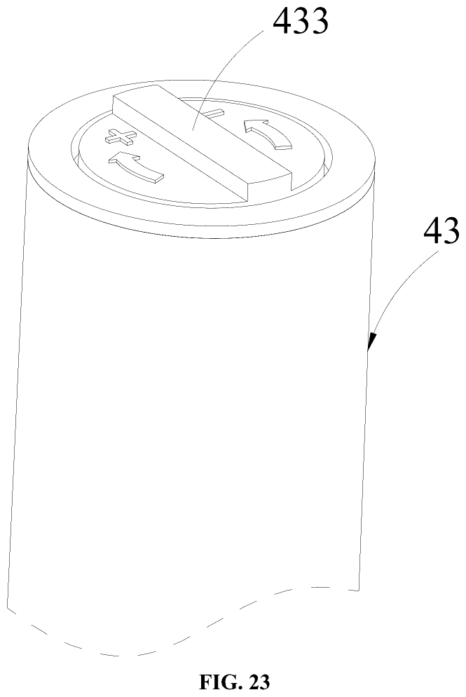

As shown in FIGS. 21 to 23, according to another example of the present application, an inflation volume of a cylinder 43 is adjustable. The other structures of the nail gun 100 provided in FIG. 1 are substantially the same as those provided in this example.

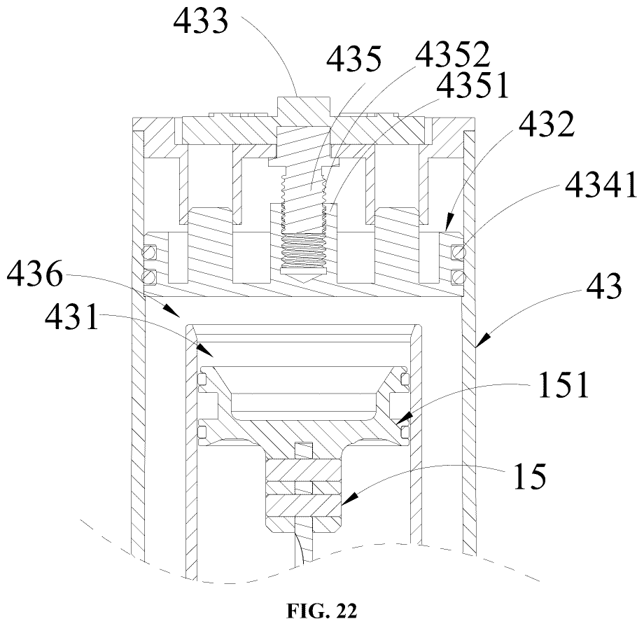

In this example, the cylinder 43 includes a first chamber 431, a second chamber 436, and an adjustment assembly 432. The first chamber 431 accommodates the piston 151, and the piston 151 moves in the first chamber 431. The second chamber 436 communicates with the first chamber 431. The adjustment assembly 432 includes a first state and a second state. When the piston 151 is at the same position in the first chamber 431, the first chamber 431 and the second chamber 436 define a first effective volume when the adjustment assembly 432 is in the first state (as shown in FIG. 22), and the first chamber 431 and the second chamber 436 define a second effective volume when the adjustment assembly 432 is in the second state (as shown in FIG. 21). The first effective volume is less than the second effective volume. The state of the adjustment assembly 432 is changed so that the inflation volume defined by the cylinder 43 is varied. Thus, a pressure in the cylinder 43 is different initially. That is to say, the pressure in the cylinder 43 is different when the firing assembly 15 is in the firing state. In one aspect, universality of the product is improved. Products with different striking force requirements may use the structure of the cylinder 43 universally, and the state of the adjustment assembly 432 is adjusted so that the different striking force requirements can be met. In this example, when the cylinder 43 is inflated with the same volume of gas, a striking force applied to the nail by the firing assembly 15 when the adjustment assembly 432 is in the first state is greater than a striking force applied to the nail by the firing assembly 15 when the adjustment assembly 432 is in the second state. The inflation volume defined in the cylinder 43 when the adjustment assembly 432 is in the first state is smaller than the inflation volume defined in the cylinder 43 when the adjustment assembly 432 is in the second state. Therefore, when the cylinder 43 is inflated with the same volume of gas, a pressure in the cylinder 43 in a case where the adjustment assembly 432 is in the first state is greater than a pressure in the cylinder 43 in a case where the adjustment assembly 432 is in the second state.

In this example, the piston 151 moves in the first chamber 431, and therefore, a volume of the first chamber 431 is related to a position to which the piston 151 moves. The second chamber 436 is disposed at an opposite upper end of the first chamber 431 and/or disposed at an opposite periphery of the first chamber 431. The adjustment assembly 432 is at least partially disposed in the second chamber 436. Therefore, the defined volume of the first chamber 431 is not related to the state of the adjustment assembly 432. The defined volume of the second chamber 436 is related to the state of the adjustment assembly 432.

The adjustment assembly 432 includes an operation member 433, an adjustment piston 434, and a connection portion 435. The operation member 433 is driven to switch the working state of the adjustment assembly 432. The adjustment piston 434 is driven by the operation member 433 to move in the second chamber 436. A sealing ring 4341 is disposed on an outer side of the adjustment piston 434. The adjustment piston 434 is hermetically connected to an inner wall of the second chamber 436. As a position of the adjustment piston 434 changes, the defined volume of the second chamber 436 also varies. In this example, the adjustment piston 434 and the inner wall of the second chamber 436 define the volume of the second chamber 436. That is to say, a volume of a portion located below the adjustment piston 434 and forming a relatively closed chamber with the second chamber 436 is the defined volume of the second chamber 436. A portion located above the adjustment piston 434 does not belong to the defined volume of the second chamber 436. The connection portion 435 connects the operation member 433 to the adjustment piston 434. The connection portion 435 is driven by the operation member 433 to move the adjustment piston 434 and retains the position of the adjustment piston 434 when the operation member 433 is released. In this example, the connection portion 435 includes a threaded movement portion 4351. The operation member 433 is formed with or connected to an adjustment portion 4352 threadedly mating with the movement portion 4351. The adjustment portion 4352 does not move in an axial direction of a displacement direction of the adjustment piston 434. When the adjustment piston 434 needs to be moved, the operation member 433 is rotated, and then the adjustment portion 4352 axially displaces the movement portion 4351 through threads. When the adjustment piston 434 moves in place, since the mutually engaged threads can retain an engaged state, the adjustment piston 434 subjected to an axial force can still be retained at a current position when an operation on the operation member 433 is released.

In this example, since the position of the adjustment piston 434 can be adjusted in a stepless manner, the adjustment assembly 432 includes various states corresponding to various positions.

In some alternative examples, the connection portion 435 may be a structure that drives an axial movement of the adjustment piston 434 through an axial movement of the operation member 433, such as a hydraulic rod or a telescopic rod. Alternatively, the adjustment piston 434 is moved by pressing the operation member 433 and releasing the operation member 433. In some examples, the position of the adjustment piston 434 may be changed through electronic control.

The basic principles, main features, and advantages of this application are shown and described above. It is to be understood by those skilled in the art that the aforementioned examples do not limit the present application in any form, and all technical solutions obtained through equivalent substitutions or equivalent transformations fall within the scope of the present application.

What is claimed is:

1. A power tool, comprising:
a housing;
a power output portion at least partially disposed in the housing;
a cylinder at least partially disposed in the housing, wherein gas is stored in the cylinder; and
a piston driven by the power output portion, wherein the piston is disposed in the cylinder and moves in the cylinder to compress gas in the cylinder;
wherein the cylinder comprises:
an inflation nozzle, wherein the cylinder is inflated with the gas in advance through the inflation nozzle;
an inflation valve, wherein the gas filled through the inflation nozzle flows through the inflation valve and then enters the cylinder; and
a pressure relief valve disposed between the inflation nozzle and the inflation valve, wherein, when a pressure of the gas filled through the inflation nozzle is greater than a first preset pressure, the filled gas is released through the pressure relief valve.

2. The power tool according to claim 1, wherein the pressure relief valve allows one-way flow.

3. The power tool according to claim 1, wherein the inflation valve allows one-way flow.

4. The power tool according to claim 1, wherein the inflation valve restricts gas in the cylinder from flowing out of the cylinder through the inflation valve.

5. The power tool according to claim 1, wherein the inflation valve restricts gas from entering the cylinder when a pressure in the cylinder exceeds a second preset pressure.

6. The power tool according to claim 5, wherein the first preset pressure is less than or equal to the second preset pressure.

7. The power tool according to claim 1, wherein the cylinder comprises:
a cylinder barrel portion provided with a chamber, wherein the chamber is configured to store gas; and
an inflation portion connected to the chamber through the inflation valve.

8. The power tool according to claim 7, wherein the inflation portion comprises a gas passage portion, the inflation nozzle and the inflation valve are disposed at two ends of the gas passage portion, and the pressure relief valve is disposed at the gas passage portion.

9. The power tool according to claim 8, wherein, when the pressure relief valve and the inflation valve are in a closed state, a gas pressure in the gas passage portion is greater than or equal to atmospheric pressure.

10. The power tool according to claim 8, wherein the gas passage portion forms a second gas chamber, the second gas chamber has a length, and the pressure relief valve releases the gas along a direction intersecting with a length direction of the second gas chamber.

11. The power tool according to claim 1, wherein the cylinder comprises an inner cylinder, and the piston moves in the inner cylinder.

12. The power tool according to claim 11, wherein the cylinder further comprises an outer cylinder disposed around the inner cylinder, the inner cylinder communicates with the outer cylinder, and the inflation nozzle, the inflation valve, and the pressure relief valve are disposed on the outer cylinder separately.

13. The power tool according to claim 12, wherein a first threaded segment is provided on an outer sidewall of the inner cylinder, a second threaded segment is provided on an inner sidewall of the outer cylinder, and the first threaded segment meshes with the second threaded segment.

14. The power tool according to claim 1, wherein the housing has an inflation hole and a retaining member comprising a positioning portion that is at least partially disposed on the cylinder and that indicates a position where the inflation nozzle is to be placed into correspondence with the inflation hole.

15. The power tool according to claim 14, wherein the positioning portion comprises a first indicating structure, the cylinder is provided with a second indicating structure, and when the first indicating structure and the second indicating structure meet a preset relationship, the cylinder is fixed at a preset position causing the inflation nozzle to correspond to the inflation hole.

16. A power tool, comprising:
a housing;
a power output portion at least partially disposed in the housing;
a cylinder at least partially disposed in the housing, wherein gas is stored in the cylinder;
a piston driven by the power output portion, wherein the piston is disposed in the cylinder and moves in the cylinder to compress the gas in the cylinder;
an inflation nozzle, wherein the cylinder is inflated with the gas in advance through the inflation nozzle; and
a one-way pressure relief valve disposed on an inflation downstream side of the inflation nozzle, wherein the one-way pressure relief valve communicates with an outside of the cylinder for an escape of the gas.

17. A power tool, comprising:
a housing;
a power output portion at least partially disposed in the housing;
a cylinder at least partially disposed in the housing, wherein gas is stored in the cylinder; and
a piston driven by the power output portion, wherein the piston is disposed in the cylinder and moves in the cylinder to compress the gas in the cylinder;
wherein the cylinder comprises:
an inflation nozzle, wherein the cylinder is inflated with the gas in advance through the inflation nozzle, and the inflation nozzle restricts the gas from being released from the inflation nozzle; and
a one-way pressure relief valve disposed on an inflation downstream side of the inflation nozzle, wherein, when a pressure of the gas filled through the inflation nozzle is greater than a first preset pressure, the filled gas is released through the one-way pressure relief valve.

18. The power tool according to claim 17, wherein the cylinder comprises an inner cylinder, and the piston moves in the inner cylinder.

19. The power tool according to claim 18, wherein the cylinder further comprises an outer cylinder disposed around the inner cylinder, the inner cylinder communicates with the outer cylinder, and the inflation nozzle and the one-way pressure relief valve are disposed on the outer cylinder separately.

20. The power tool according to claim 19, wherein a first threaded segment is provided on an outer sidewall of the inner cylinder, a second threaded segment is provided on an inner sidewall of the outer cylinder, and the first threaded segment meshes with the second threaded segment.
